(19) United States
(12) Patent Application Publication
(10) Pub. No.: US 2017/0003664 A1
(43) Pub. Date: Jan. 5, 2017

(54) Equipment Isolation System

(71) Applicant: Remsafe Pty Ltd, BALCATTA Western Australia (AU)

(72) Inventors: Michael Charles Lane, Dianella (AU); Kazimierz Kacperek, Ocean Reef (AU); Jack Mross, Fremantle (AU)

(21) Appl. No.: 15/199,676

(22) Filed: Jun. 30, 2016

(30) Foreign Application Priority Data
Jun. 30, 2015 (AU) 2015902554
Jun. 30, 2015 (AU) 2015902557

(51) Int. Cl. G05B 9/02; E21F 13/00

(52) U.S. Cl. CPC G05B 9/02; E21F 13/00

(57) ABSTRACT

An equipment isolation system (10) comprising equipment (20,21) energisable by an energy source (30), a control system (50,260) for controlling operation of said equipment (20,21) and which enables isolation of said equipment (20,21) from said energy source (30) when an isolation request for said equipment (20,21) is authorised by the control system (50,260) and an isolation system switch means (400, 585,650) operable by an actuating device (500) for switching said isolation system (10) between operative and inoperative states under determined conditions.

This invention relates to an equipment isolation system. More specifically, the invention relates to an equipment isolation system where the isolation system can be bypassed under specific conditions to quickly return the equipment to a normal operating state.

Various types of equipment must be isolated from a range of energy sources including electrical energy (the most common) and mechanical energy including pressure and potential energy to enable safe maintenance and other work to be carried out. Conveyor belt systems used in the mining industry for transporting iron ore or other bulk materials, and which can span significant distances, are one such example of equipment which may require to be isolated from time to time.

The distances such conveyor belt systems can span can be in the range of many kilometres. Such conveyors are typically powered by electric drive motors: three phase electrical power is supplied wherein the voltage may range from low voltage ranges (from below 600V to 1000V AC), to medium and high voltage ranges (in the multiple kV range and extending to above 10 kV AC and even 33 kV AC). Such conveyors typically include brake systems which are also electrically operated.

Although different mine procedures and relevant safety standards may apply, a typical pre-requisite before permitting mechanical maintenance or other activity involving access to the conveyor belt system involves the electrical isolation of the conveyor belt system. This isolation ensures that the energy source powering the conveyor belts and associated equipment, i.e. electrical power, is removed from systems that—if energised—could cause a safety hazard. It will however be understood that equipment items other than conveyor systems and other than mining industry equipment also require isolation for maintenance and other purposes.

The isolation process is invariably safety critical and has, in the past, been time consuming, as described for example in the introduction to the Applicant's granted Australian Patent No 2010310881 and International Publication No. WO 2012/142674, the contents of which are hereby incorporated herein by reference.

The remote isolation system described in Australian Patent No. 2010310881 enables equipment isolation to be requested at a remote isolation station associated with the equipment and subsequently approved through a plant control system, without mandatory visitation to the equipment by authorised isolation personnel. This remote isolation system significantly reduces time for achieving safe isolation, especially production downtime which can be very costly.

Under certain circumstances or as a result of specific conditions—such as faults—being satisfied, the remote isolation system may require switching of a remote isolation station between a normal isolation mode and a bypass mode in which the isolated equipment is quickly placed back into a normal mode of operation. For example, equipment isolation systems have been known to fail and will go into lock down if certain faults are registered or if illegal access or operation of the equipment is detected. Such scenarios can lead to hours of valuable production time being consumed troubleshooting the isolation system to get the plant back into a normal operating mode. This can cause significant frustration and lost production time for operators where they can quickly deduce that a fault or the like has caused the equipment to enter an isolation mode, but where they cannot quickly return the equipment to the normal operating mode.

An object of the present invention is to provide a remote isolation system where the isolation system can be bypassed under specific conditions to quickly and easily return the equipment to a normal operating state. This object and potential benefits of the invention extend beyond equipment isolation systems developed by the Applicant.

With the above object in view, the present invention provides an equipment isolation system comprising:
equipment energisable by an energy source;
a control system for controlling operation of said equipment and which enables isolation of said equipment from said energy source when an isolation request for said equipment is authorised by the control system; and
an isolation system switch means operable by an actuating device for switching said isolation system between operative and inoperative states under determined conditions.

The inoperative state may also be called bypass or maintenance mode in which the isolation system is itself isolated from the equipment rendered temporarily inoperative for example for determined conditions such as maintenance or to address an isolation system fault (and typically in less time than a troubleshooting process to locate the fault would require). When the fault is rectified, the equipment isolation system may be reset and returned to normal service. The inoperative state may also allow the equipment isolation system to be substituted by an alternative equipment isolation system or process, such as manual isolation, since bypass should not be initiated when equipment is in an isolated state.

The isolation system switch means, whilst it conveniently is, or includes, an equipment isolation switch (isolation lockout switch) required for isolating equipment, performs the task of switching the isolation system itself between operative and inoperative or bypass states. The isolation system switch means could also be at least one dedicated bypass switch operated with a bypass actuating device or key not associated with the isolation lockout switch. The isolation system switch means may, for reasons given below, include a plurality of switches each operated by an actuating device, desirably a unique actuating device.

Deactivation for bypass must be achieved in a safe but efficient manner and this typically requires the isolation switch means to include a plurality of switches which must be operated in a determined sequence to complete switching of the equipment isolation system between operative and inoperative states. Such switches as required for switching the isolation system from operative to inoperative states cannot be activated in a random sequence. A determined switching sequence—which corresponds with the sequence of steps or tasks which must be safely completed to complete the required switch in operating state—is required.

Conveniently, each switch of the isolation system switch means is most advantageously operated by an actuating device in the form of a key(s) which may be selected from the group consisting of mechanical, electronic or electro-mechanical devices including smart devices. Keys may also reside in passwords, other codes (numeric, alphanumeric and other formats) and electrical signals. By “dedicated key” it is intended that the key should be unique and, in addition and ideally, not duplicated or interchangeable with another. Keys and actuating devices generally may be multi-functional being used to implement additional tasks in the isolation system than just actuating one switch.

Where mechanical keys are used, the isolation system switch means may include a switch module in the same form as a conventional lock, for example a cylinder-lock working on a pin and tumbler principle. For reasons described above, the key is desirably both unique to the equipment isolation switch and removable under prescribed circumstances, the key circumstance being a requirement for deactivation of the equipment isolation That is, removability of the key from its corresponding equipment isolation system is important as without this capability bypass of the isolation system cannot be effected.

The isolation system switch means, especially where it includes an isolation lockout switch, may be comprised within a replaceable switch module or barrel which is advantageous under certain circumstances. For example, safety is a paramount consideration and, for this reason, it is undesirable to provide duplicate actuating devices with it being highly preferable for a unique actuating device to be provided to co-operate with any equipment isolation switch. Accordingly, if the actuating device is lost or stolen from the switch, even if intended to be removable under prescribed circumstances described below, replication is avoided and no replacement is available. Rather, the switch module is replaced with a substitute switch module including its corresponding actuating device following any required authorisation procedure. The original switch module may then be refurbished with a substitute actuating device in a manner with substantially lesser risk than encountered with duplicate actuating devices.

The actuating device is preferably a dedicated bypass actuating device such as a dedicated bypass key. The dedicated bypass key may normally co-operate with the isolation switch means but other options are possible. For example, a key may be held at a central location, for example as a master bypass key, being used to operate the isolation switch means to bring the equipment isolation system into an inoperative or bypass state.

The equipment isolation system is advantageously a remote isolation system. Desirable remote isolation systems include those described in Australian Patent No. 2010310881 and the Applicant's Australian Provisional Patent Application Nos. 2015902554, 2015902556, 2015902558, 2015902559, 2015902561, 2015902562, 2015902564, 2015902565 and 2015902566 each filed on 30 Jun. 2015, the contents of which are hereby incorporated herein by reference. In such systems, the control system would typically automatically isolate equipment by isolating electrical contactors de-energising the equipment in response to a permissible operator request lodged at a remote isolation station corresponding to the equipment to be isolated and provided with an isolation lockout switch for the equipment, preferably and advantageously as described in Australian Provisional Patent Application No. 2015902554. The isolation lockout switch may form at least one switch of the isolation switching means. A remote isolation station could include other switch(es) for switching the isolation system from an operative to an inoperative state.

In one scenario, under controlled conditions where bypass of the isolation system is required and equipment is not isolated, the key is a first key—for example normally held captive within the isolation lockout switch—which would be removed from the isolation lockout switch when bypass is required. Where a remote isolation station including the isolation lockout switch is involved, the key may also be removed from the remote isolation station.

Such removal of an isolation system switch means key is permitted by the isolation system switch means only when the associated equipment item(s) is (are) in normal position, not an isolated position. Such deactivation for bypass under determined conditions includes requirement for other tasks to be completed before a remote isolation system is safely and completely removed from service.

At least one switch of the isolation system switching means may be included within a key exchange unit which supplies, on successful operation, key(s) to implement additional task(s) in the isolation system, for example by operating any further switch or lock in the determined sequence in exchange for the appropriate key obtained for a preceding step in the switching process.

Thus, in a further embodiment, the present invention provides an equipment isolation system comprising:
a first key operable to implement a first task for said isolation system;
a second key dedicated, on operation, to implement a second task for said isolation system; and
a key exchange unit for receiving said first key and rendering operable a second key in exchange for said first key when said first key is accepted by the unit.

It will be understood that this embodiment does not require the keys to be used simply for switching the equipment isolation system between operative and inoperative states and vice versa.

The first and second tasks for the isolation system may be the same or different. Where the tasks are the same, completion of the task will not occur until both keys have been operated. The first and second tasks may involve lock opening or closing operations, for example for switches forming part of the isolation system and gates or doors to safety critical infrastructure in an industrial plant, for example a material handling plant. Safety critical infrastructure may include sub-stations or remote isolation stations forming part of a remote isolation system such as that described in the Applicant's Australian Patent No. 2010310881.

The key exchange unit may provide for validation of the first key prior to acceptance of the first key by the exchange unit. Validation would typically involve an electronic process. If the exchange unit and key are mechanical or electronic devices where the key is received in a socket, physical congruence of key and socket could provide sufficient validation. However, as isolation systems are safety critical, it may be desirable to add a further layer of security so that, even if the first key is received by the unit, a further validation step occurs before the further or second key is rendered operable, typically by being dispensed from the key exchange unit. For example, a control system may check that the isolation system requires, or makes it safe for, the second task to be conducted.

The first key may operate a switch selected from the group consisting of an isolation lockout switch and a bypass switch (where provided); and the further key operates a bypass switch or a plurality of bypass switches. Bypass switches may be used for various tasks. For example, each bypass switch may operate an electrical isolator for isolating the isolation system. A bypass switch may operate to release a tool for use in isolating the isolation system. These options are described further below.

The switches may be spatially separated, possibly by substantial distance, requiring transport of an operator to operate the switch. This may be desirable for safety reasons, the travel time interval allowing time for safety checks and reflection on the appropriateness of switch operation.

This first key referred to above may also be referred to as field isolation station (FIS) key and there may be more than one FIS key, each being associated with an equipment isolation lockout switch of a remote isolation station in the isolation system in which case there may be a plurality of first or FIS keys. The FIS keys are not interchangeable. FIS keys are required to be removed from all isolation lockout switches in order to enable a bypass mode to be entered for a remote isolation system.

Continuing discussion of the above-mentioned scenario, a suitably located and configured key exchange station (KES) may house a primary bypass key (PBK) which is required to be released and used in order for the remote isolation system to be placed into a bypass mode. The KES is preferably located at a central location such as a sub-station providing electricity to the equipment. Inserting and operating the required FIS keys, which should include all FIS keys, in the required switches in the KES enables the primary bypass key (PBK) to be rotated and removed, through a cascaded mechanical interlock, for use in its associated bypass electrical switch assembly, effectively in exchange for the FIS key(s). In embodiments such as this, the FIS keys are multi-functional being used to implement additional tasks in the isolation system than just actuating the equipment isolation switch.

Use of the PBK is by placing and rotating it in an adjacent key cylinder on the KES to release one or more Secondary Bypass Keys (SBK) which together with operation of a corresponding bypass electrical switch assembly (second bypass switch) or isolators located on an electrical switchboard of an isolation control system for the remote isolation system may enable the system to be bypassed and to hence be returned to a normal operating mode. More specifically, use of the PBK may, alone or in combination with further keys as described below, enable the isolation control system to disengage the aforementioned electrical contactors and other isolators from the equipment isolation system. A plurality of isolators may require to be operated to bypass the isolation system, a dedicated PBK key being required for manual operation of each isolator and delivered by the KES in analogous manner to that described above. Conversely, such manual operation of isolator(s) is prevented because the necessary keys are locked in the KES when FIS keys are installed in their corresponding isolation lockout switches. Rather, the control system of the remote isolation system controls the isolators.

It will be understood that the PBK itself may also be required to be operated in a further switch in the KES to release one or more secondary bypass key(s) (SBK) to be used in corresponding bypass switch(es) prior to system bypass and a return to a normal operating mode. Such SBK keys can also be used for releasing equipment from a stored position for use during the bypass process (or the reverse). For example, a SBK may be used to rotate an access flap for a socket so that a crank lever can be inserted and used for manual racking of high voltage racked electrical contacts. SBK keys could also be used to lock or unlock access doors for components of the remote isolation system. As many such keys and switches as necessary can be provided for. Importantly, the PBK and SBK keys are not interchangeable between each other or the FIS keys.

The equipment isolation system may be substituted, when in inoperative state, by an alternative equipment isolation system or process such as a manual isolation process.

Even when the isolation system is bypassed, monitors may continue to be used for securing the components of the equipment isolation system such as remote isolation stations. Such monitors are described in the Applicant's Australian Provisional Patent Application No. 2015902556, the contents of which are incorporated herein by reference.

It is of course to be understood that the equipment isolation system may be of different design than the above described remote isolation systems. The present invention is hence not solely confined to use in the Applicants remote isolation systems.

The equipment isolation system may include more than one key exchange unit, particularly for more complex systems with multiple controllers and/or isolation workflows requiring a plurality of tasks to be completed. Inclusion of further key exchange units provides further safety assurance for such equipment isolation systems.

Notwithstanding the above description in the context of isolation from electrical energy, it will be understood that the equipment isolation system is suitable for isolating equipment from various energy sources whether electrical, thermal or mechanical in nature and from combinations of energy sources including electrical energy, kinetic energy and potential energy.

The term “isolation” as used in this specification is to be understood in its maintenance engineering and legal sense as not simply turning off a supply of energy to equipment, whatever the nature of that energy, but removing and/or dissipating energy to provide a safe work environment as required by applicable occupational health and safety regulations. In the case of electricity, as just one example, isolation is not achieved simply by turning off a power supply to the equipment. In such cases, the equipment could accidentally re-start or be restarted and cause injury to personnel, or worse. Isolation instead prevents such accidental re-starting and typically will also involve processes to dissipate any hazardous stored energy, in whatever form that energy may take (e.g. potential energy), from the equipment. For example, such an additional energy dissipation step could be effected in respect of a conveyor belt system by way of the braking cycle procedure as described in the Applicant's Australian Provisional Patent Application No. 2015902565, the contents of which are incorporated herein by way of reference.

The equipment isolation system may be more fully understood from the following description of a preferred embodiment made with reference to the accompanying drawings in which:

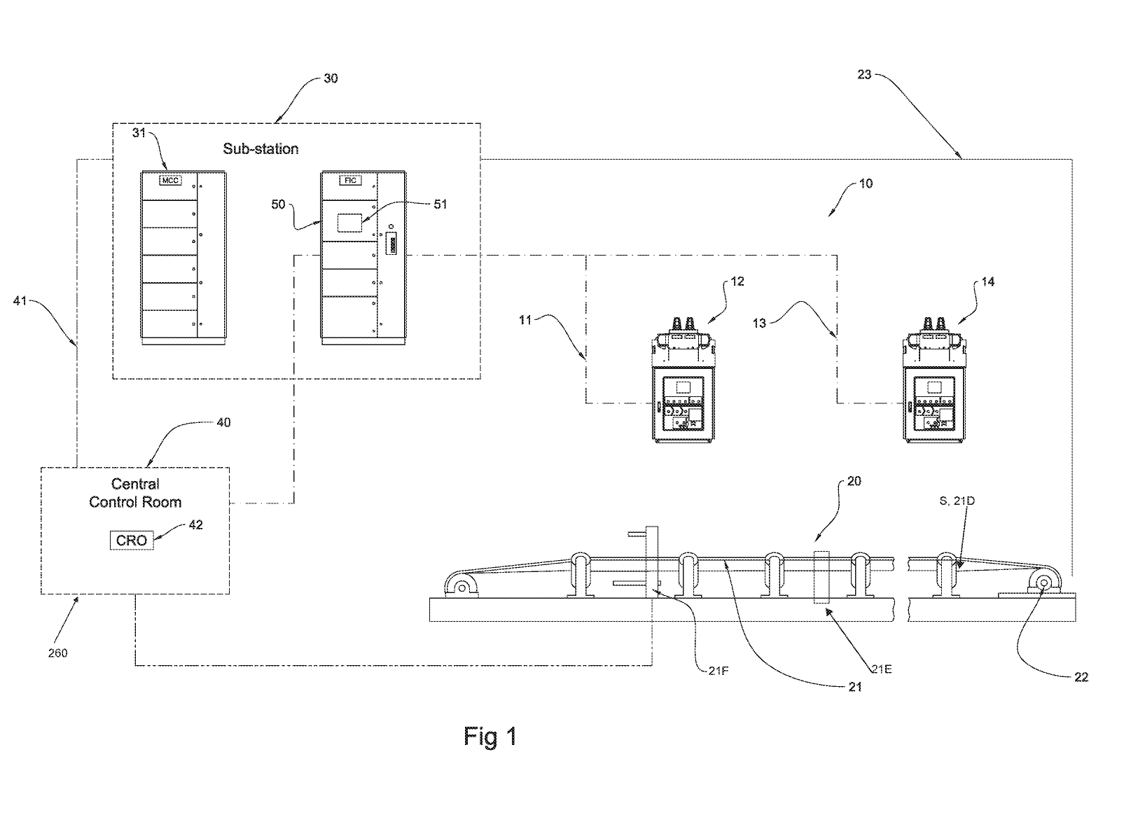

FIG. 1 shows a schematic layout of an equipment isolation system as applied to a conveyor belt system and configured in accordance with one embodiment of the present invention.

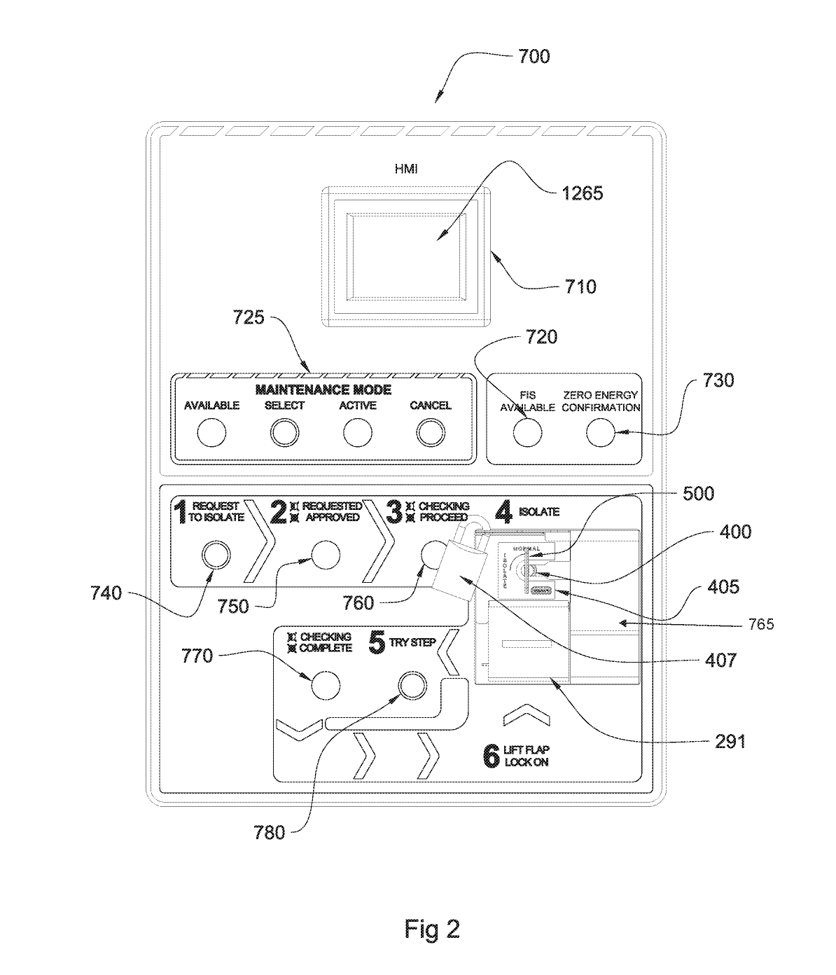

FIG. 2 shows a schematic of a control panel for use in the remote isolation systems schematised in FIG. 1.

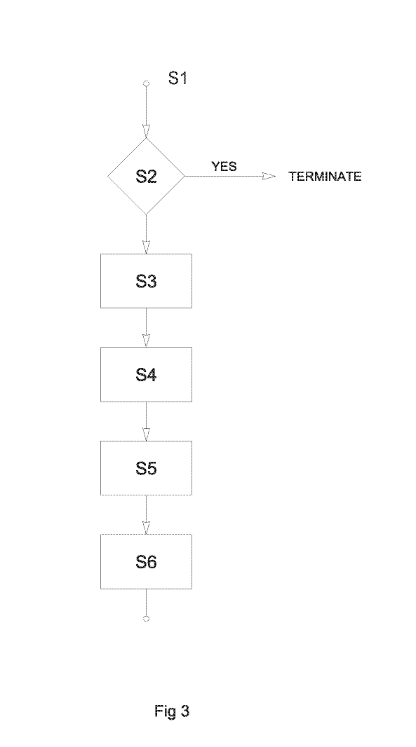

FIG. 3 shows a flowchart showing the sequence of steps in bypassing the equipment isolation system of one embodiment of the present invention.

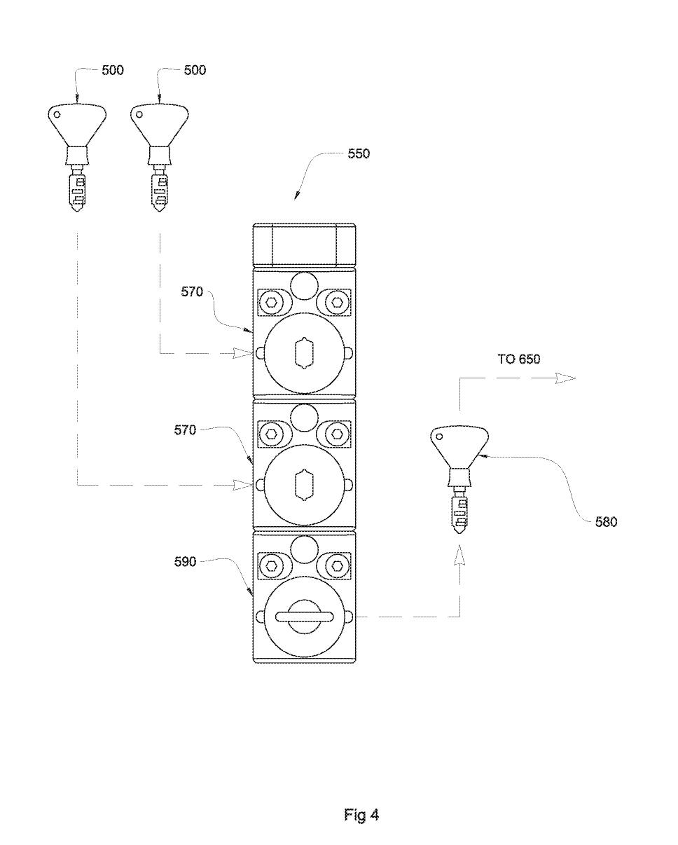

FIG. 4 shows a schematic of a key exchange unit for use in bypassing the equipment isolation system shown in FIG. 1 using the procedure schematically shown in FIG. 3.

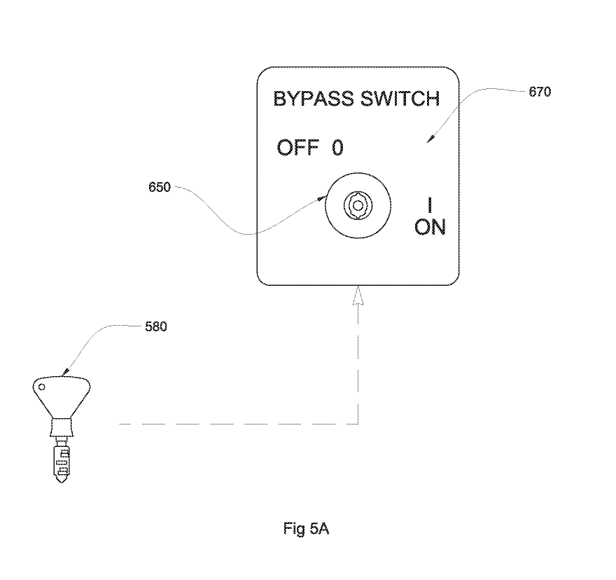

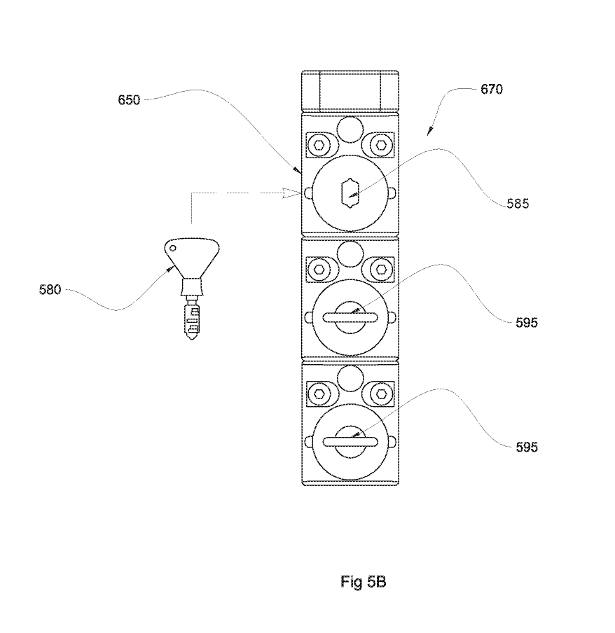

FIG. 5A shows a schematic of a first form of an electrical switchboard forming a part of the equipment isolation system shown in FIG. 1.

FIG. 5B shows a schematic of a second form of an electrical switchboard forming a part of the equipment isolation system shown in FIG. 1.

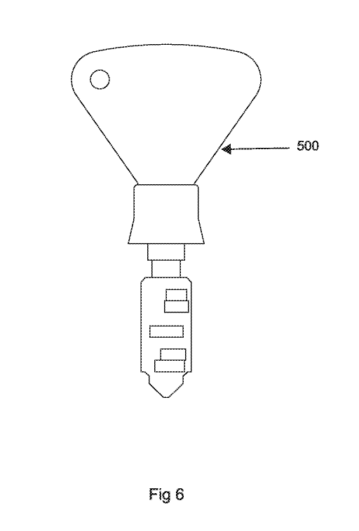

FIG. 6 shows a perspective view of a key used in the equipment isolation system shown in FIG. 1.

Referring to FIG. 1, there is shown a schematic layout of a remote isolation system 10, as retrofitted on to an existing conveyor belt system 20, for example a long overland conveyor system for conveying iron ore from a mine site to a port for shipment. The conveyor belt system 20 comprises a troughed conveyor belt 21 having a head pulley motor 22 driven by an electrical supply emanating from electrical contacts 31, whether provided as contactors or circuit breakers. One contact is a standard contactor for “ON”/“OFF” operation of the motor 22. The head pulley motor 22 is powered through a variable speed drive (VSD) which is electrically powered from a 3 phase AC power supply line 23 providing voltages of less than 1000V AC. The electrical power is supplied from a sub-station 30. The sub-station 30 houses the contacts 31. Activation of the contacts 31 (i.e. placing them in the “off” or “break” state), de-energises all 3 phases of the electrical supply to the conveyor head pulley drive motor 22. Such de-energisation is continuously monitored by a voltage monitor relay (not shown) located downstream of contacts 31, i.e. on the conveyor belt system 20 side of the contacts 31.

Conveyor belt system 21 also includes a braking system 21E, a tramp metal detector (TMD) 21F and a belt movement sensor S, 21D, the use of which is described in the Applicant's Australian Provisional Patent Application Nos. 2015902554 and 2015902565, the contents of which are incorporated herein by reference.

The conveyor belt system 20 and sub-station 30 are under the control and supervision of a plant control system 260 having a central control room (CCR) 40, via a DCS (Distributed Control System) or SCADA (Supervisory Control and Data Acquisition System) as are commonly used and would be well understood by the skilled person. Item 41 in FIG. 1 is representative of a communication and control network between the CCR 40 and various other plant systems and components. A Control Room Operator (CRO) 42 is located within the CCR 40 and has various input/output (I/O) devices and displays available (not shown) for the proper supervision and control of the conveyor belt system 20. Except for the remote isolation system 10, the above description represents what may be considered a conventional system in the materials handling and mining industries.

The remote isolation system 10 comprises fixed remote isolation stations 12 and 14 which are located proximate to the conveyor belt system 20. It will be understood that remote isolation stations 12 and 14 could be replaced or supplemented by one or more mobile isolation stations, for example in the form of a portable computer device or communication device using wireless communications, as disclosed for example in the Applicant's Provisional Patent Application Nos. 2015902561 and 2015902562, the contents of which are incorporated herein by way of reference. The remote isolation stations 12 and 14 may be powered from the plant grid, other power networks or alternative power sources, conveniently such as solar power.

The remote isolation system 10 also includes a master controller 50 incorporating a human/machine interface (HMI) in the form of a touch sensitive screen 51 which displays human interpretable information. The master controller 50 is also located within sub-station 30. Remote isolation stations 12 and 14 are in communication with master controller 50 and each other via communication channels 11 and 13 using an open communications protocol. These communication channels can be provided in any suitable form including hard wired or wireless forms with Ethernet communications being particularly preferred to enable flexible system updating on site. Communications must be via safety rated communications protocol software such as Interbus Safety or PROFIsafe which are well known within the mining industry. This will ensure that the communication channels are monitored and diagnostic tools are available for fault control and rectification when required.

Further description of the electrical layout and operation of the remote isolation system 10 is provided in the Applicant's granted Australian Patent No. 2010310881, the contents of which have been incorporated by reference, In summary, the conveyor belt system 20 is isolated by a process involving the following logical sequence of steps:
Operator request at remote isolation station 12 or 14 for the control system to approve isolation of all or part of the conveyor belt system 20 including conveyor 21 and drive motor 22 in accordance with a preferred mode of isolation developed by the Applicant and described in co-pending Australian Provisional Patent Application No. 2015902558, the contents of which are incorporated herein by reference;
Isolation being approved if the operator request meets permissives for isolation, for example as described in Australian Patent No. 2010310881;
Isolation automatically implemented;
A try step process being invoked to check that the isolation is effective, which involves checking that electrical contacts 31 for the conveyor belt system 20 are in an isolated position with no voltage being detected by the voltage monitor relay downstream of the electrical contacts 31 (and desirably, conveyor belt movement sensors such as movement speed sensor S and/or belt movement sensor 21D confirming that the conveyor belt 21 has come to a complete stop as described below); an attempt to restart the conveyor belt system 20 using a try step process or an automated process; and checking that there is no re-energisation of conveyor belt system 20 using the same sensors; and
Lockout at a control panel of remote isolation station 12 and/or 14 if the try step process is unsuccessful (as desired).

FIG. 2 shows a schematic of a control panel 700 arranged as part of each of remote isolation stations 12 and 14 for implementing the Applicant's remote isolation system. Panel 700 has a human machine interface (HMI) 710 with a touch screen 1265 (though less fragile buttons, switches and other input devices may be used in alternative arrangements) for entering commands, including issuing isolation requests to the plant control system). Information can also be presented on screen 1265 in respect of any such isolation requests including isolation status and plant data.

Control panel 700 also includes:
indicator light 720 showing whether or not the remote isolation station (FIS) 12 or 14 is available for isolation;
indicator light block 725 showing whether or not exclusive or maintenance mode for the remote isolation system is active (with the remote isolation station 12 exclusively controlling operation of the conveyor belt system 20),; and respective “select” and “cancel” buttons for initiating or terminating the maintenance mode;
indicator light 730 to provide zero energy confirmation when sensors, such as at least the voltage monitor relay described above for contacts 31, and preferably the conveyor belt movement sensor 21D as well, indicate zero hazardous energy in the conveyor belt system 20 (i.e. a zero energy indication is achieved when the culmination of all energy sources being monitored confirms that there is no stored or latent energy (whether potential, or electrical etc) remaining in the system desired to be isolated);
request to isolate button 740 which is activated by an operator (and which illuminates when pressed) to request isolation and “request approved” and indicator light 750 which illuminates to provide status information to said operator;
indicator light block 760 for showing correctness of selection of conveyor belt 21 for isolation and for indicating that control system checking is taking place subsequent to an isolation request being instigated;
indicator light block 770 for showing whether or not the isolation process is complete following control system checking; and
graphics (in the form of arrows and text) illustrating the sequence of steps to be followed in the required isolation procedure.

Control panel 700 also includes an equipment isolation switch 765 which prevents completion of the isolation process by locking with an operator's padlock or hasp until the correct remote isolation procedure, for example as described in Australian Patent No. 2010310881, has been completed. In particular, a correct remote isolation procedure requires a try start step to be completed by an operator by activation of a try step button 780 before any manual lock out is possible. The equipment isolation switch 765 is designed to prevent any such manual lock out before the correct isolation procedure has been completed.

Equipment isolation switch 765, a preferred switch as described in Australian Provisional Patent Application No. 2015902554, also includes an isolation lockout switch 400 operable by turning a first FIS key 500 between a first “NORMAL” position in which the drive motor 22 for the conveyor 21 is electrically energised (i.e. not isolated) and a second “ISOLATE” position in which the drive motor 22 is electrically isolated and thus without power thereby facilitating any maintenance works which may be required. FIS key 500 is dedicated to isolation lockout switch 400 and unique. It cannot be replicated or duplicated in event of loss. Each remote isolation station 12 and 14 has a different isolation lockout switch 400 with a separate non-interchangeable unique FIS key 500.

Key 500 is in the NORMAL position in isolation lockout switch 400 in FIG. 2, Key 500 is also shown in greater detail in FIG. 6. It will be understood that switching from NORMAL to ISOLATE positions requires operation of first FIS key 500 when the above described equipment isolation system is used.

Referring to the flowchart of FIG. 3, and specifically considering a situation where a fault is detected in the remote isolation system 10, for example at remote isolation station 14, a bypass procedure is initiated at step S1. The aim of the bypass procedure is to quickly and easily return the plant to a normal mode of operation without the need for significant troubleshooting efforts being required (and hence wasted production time) to rectify the problem or fault with the remote isolation system 10. The bypass procedure involves an isolation system switch means including a plurality of switches, one class of which includes isolation lockout switches 400 located at each remote isolation station 12 and 14.

At step S2, the CRO/control system 42/260 checks whether the conveyor belt system 20 is currently isolated by the remote isolation system 10. If the equipment is isolated, the bypass procedure must be terminated. In operative state for remote isolation system, each FIS key 500 is held captive in isolation lockout switch 400 (using the keeper plate 405 and padlock 407 arrangement as shown in FIG. 2 which must be unlocked when bypass mode is required). In isolated condition, a lockout flap 291 and its attached personal lock or hasp further prevents removal of a FIS key 500 from isolation lockout switch 400 as described in the Applicant's Australian Provisional Patent Application No. 2015902554.

Steps S1 and S2 may be completely automated. However, the bypass procedure involves further physical tasks to be completed as described below.

At step S3, an operator is authorised to remove first FIS key 500 from the isolation lockout switch 400 at each of remote isolation stations 12 and 14, so removing them from operation (first task). Importantly, each FIS key 500 for the remote isolation stations 12 and 14 is configured to be withdrawable from the isolation lockout switches 400 as, without this feature, the bypass process would not be able to be achieved.

Furthermore, a FIS key 500 can only be removed from an isolation lockout switch 400 when it is in the “NORMAL” position, meaning that any personal isolation locks will have had to have been removed from the equipment isolation switch 765. The removal of all such personal locks or hasps is essential to effect a bypass of the remote isolation system as it ensures the system cannot be bypassed whilst personal isolation locks are applied and hence while mine site personnel may be working on the isolated equipment. Keeper plate 405 and padlock 407 may not be removed until personal lock removal is complete.

At this stage, remote isolation stations 12 and 14 are unavailable for use in the remote isolation system 10 though monitoring of the security and serviceability, with suitable securing means as described in the Applicant's Australian Provisional Patent Application No. 2015902556, and this may continue during their unavailable period. The remote isolation system 10 is however not safely over-ridden until the electrical supply to the conveyor belt system 20—and interlocked with the remote isolation system 10—is disengaged from the remote isolation system 10. This requires further steps to be taken.

At step S4, the FIS keys 500 corresponding to remote isolation stations 12 and 14 are removed from their respective isolation lockout switches 400 and taken to a key exchange unit (key exchange station KES 550). Bypass is not otherwise possible. Key exchange units are available for other applications and, once appropriately configured in line with this description, may be used in the equipment isolation system. FIS keys 500 are inserted into respective sockets 570 of KES 550 as shown in FIG. 4.

KES 550 is located at a different physical location to remote isolation stations 12 and 14, rather being located at a cubicle (FIC cubicle) in sub-station 30 described above. Turning each FIS key 500, when accepted in socket 570 of KES 550 to a release position, allows release of at least one primary electrical interlock bypass key (PBK) 580 when rotated and removed, through cascaded mechanical interlock in KES 550, from socket 590 (i.e. effectively in exchange for FIS keys 500). PBK 580 may have similar design to FIS keys 500, again being unique and specifically dedicated to its tasks.

It will be understood that PBK 580 cannot be released prior to authorised removal of all the FIS keys 500 from remote isolation stations 12 and 14, this confirming, as an essential safety feature, that conveyor belt system 20 is in normal operating condition without operator isolation lockout.

At step S5, and as shown in FIG. 5A, electrical interlock bypass key (PBK) 580 is inserted into a socket 650 of a bypass electrical switch assembly or isolator 670 located on an electrical switchboard. The electrical switchboard is located at sub-station 30. PBK 580 is then manually turned to operate an isolator and over-ride the electrical interlock between remote isolation system 10 and contacts 31 (second task). This would be prevented during normal operation of the remote isolation system 10 as the PBK 580 is locked in KES 550 with opening FIS keys 500 being unavailable being in their normal positions in isolation lockout switches 400 at remote isolation stations 12 and 14. It will be understood that a plurality of isolators may require to be operated to bypass the isolation system, a dedicated PBK key 580 being required for manual operation of each isolator and delivered by the KES 550 in analogous manner to that described above.

The remote isolation system 10 is now inoperative or “out of service” and, in effect, has been bypassed such that the conveyor belt system 20 and head pulley motor 22 can be returned to a normal mode of operation.

The bypass means may also require use of secondary bypass key(s) (SBK) 595 as may be seen with reference to FIG. 5B. Such secondary bypass keys (SBK) 595, again of similar design to FIS keys 500 and PBK 580, would be released by inserting and operating PBK 580 within a further slot 585 of the KES 550 because a number of functions may require bypass before the equipment isolation system is removed from service. For example, SBK 595 may be required to bypass remote isolation of the brake system for conveyor belt 21.

SBKs 595 could also be used during bypass of the isolation system for the high voltage supply to drive the conveyor belt system 20. The isolation contacts for this high voltage drive are rackable and involve racking of contacts into and out of place through movement of a high voltage truck (i.e. for use in de-isolating or isolating the isolation system). On bypass, the contacts must be racked in through a manual process involving cranking with a manual over-ride crank lever. An SBK 595 released from KES 550 may be operated to unlock the over-ride crank lever for use from a stored position and used to rotate an access flap for a socket so that a crank lever can be inserted and used for The high voltage truck can then be racked into desired operating position by manual cranking of the over-ride crank lever in the socket. Particular safety precautions must be taken to mitigate risk of arc flash when this step is conducted.

It will hence be understood that the remote isolation system 10 can quickly and easily be ‘taken out of service’ through a series of straightforward key implemented tasks which avoids risk of inadvertent bypass and quick exit from the process if the bypass procedure is found unwarranted. Accordingly, the conveyor belt system 20, including the head pulley motor 22, may be restored to a production or normal operating state with a very simple, safe and effective means using bypass keys including FIS keys 500, PBK(s) 580 and, when required, SBK keys 595. Thus, rather than having to troubleshoot and then repair the isolation system which may consume hours of valuable production time, if the fault is known to be with the isolation system, significant downtime can be avoided by being able to place the plant back into a production state with a minimum of delay. Once that is assured, the remote isolation system 10 can have any faults rectified and be reset ready for use when required. It then follows that, when the system is not in bypass, manual operation of the isolators is inhibited by virtue of the isolation switch keys 500 being retained and in use at respective isolation stations 12, 14.

It will be understood that the above description is simplified to ease understanding. Further tasks may be required to complete the bypass procedure depending on the precise configuration of the remote isolation system 10 and its interlocks with a particular plant. Such tasks would need to be included within the bypass procedure flowchart of FIG. 3.

It will also be understood that returning the remote isolation system 10 to normal operating condition simply requires a reversal of the above procedure.

Modifications and variations to the isolation system of the present disclosure may be apparent to the skilled reader of this disclosure. Such modifications and variations are deemed within the scope of the present invention. For example, the equipment isolation system is not confined to use in material handling systems or conveyor systems.

Furthermore, while the control panel 700 has primarily been described as including a human machine interface (HMI) 710 with a touch screen 1265 and a series of buttons and lights (e.g. 740, 750, 760, 770, 780 etc) to enable an operator to request an isolation event, it should be noted that the control panel 700, and specifically the touch screen 1265, may be configured to provide greater control and more information about isolation system steps to an operator (or indeed full control and all information to do with the isolation system). That is, a more ‘digitally’ based input means (or indeed a totally digital system) may be arranged for operation instead of an analogue or part analogue system as described herein to enable control of the equipment isolation system according to the present invention.

1. An equipment isolation system comprising:
equipment energisable by an energy source;
a control system for controlling operation of said equipment and which enables isolation of said equipment from said energy source when an isolation request for said equipment is authorised by the control system; and
an isolation system switch means operable by an actuating device for switching said isolation system between operative and inoperative states under determined conditions.

2. An equipment isolation system as claimed in claim 1 wherein said isolation system switch means is an isolation lockout switch for said equipment.

3. An equipment isolation system as claimed in claim 1 wherein said isolation system switch means includes a plurality of switches each operated by an actuating device.

4. An equipment isolation system as claimed in claim 3 wherein said plurality of switches includes an isolation lockout switch for said equipment.

5. An equipment isolation system as claimed in claim 1 wherein said switch means includes at least one dedicated bypass switch operated by an actuating device.

6. An equipment isolation system as claimed in claim 3 wherein said switch means includes a plurality of switches which must be operated in a determined sequence to complete switching between operative and inoperative states.

7. An equipment isolation system as claimed in claim 1 wherein each switch of said isolation system switch means is operated by actuating device(s) in the form of key(s) selected from the group consisting of mechanical, electronic and electro-mechanical devices including smart devices, passwords, other codes (numeric, alphanumeric and other formats) and electrical signals.

8. An equipment isolation system as claimed in claim 1 wherein each said actuating device of said isolation switch means is unique and non-interchangeable.

9. An equipment isolation system as claimed in claim 8 wherein a switch of said isolation system switch means comprises a replaceable switch module requiring replacement in case of loss of the actuating device.

10. An equipment isolation system as claimed in claim 1 being configured to enable deactivation of the isolation system to inoperative state on removal of at least one actuating device for a switch of said isolation system switch means from co-operation with said switch.

11. An equipment isolation system as claimed in claim 1 wherein said actuating device includes a key removable from at least said isolation lockout switch only when the associated equipment item is in normal operating condition, not the isolated condition.

12. An equipment isolation system as claimed in claim 1 wherein said actuating device is multi-functional being used to implement additional tasks in the isolation system than just actuating one switch.

13. An equipment isolation system as claimed in claim 12 wherein said actuating device is a key and at least one switch of said isolation system switch means is included within a key exchange unit which supplies, on successful mechanical operation, at least one further key to implement an additional task in a switching process in exchange for a first key obtained for a preceding task in said switching process.

14. An equipment isolation system as claimed in claim 13 wherein said first key operates a switch selected from the group consisting of an isolation lockout switch and a bypass switch; and said further key operates a bypass switch.

15. An equipment isolation system as claimed in claim 14 including a plurality of bypass switches.

16. An equipment isolation system as claimed in claim 14 wherein each said bypass switch operates an electrical isolator for isolating the isolation system.

17. An equipment isolation system as claimed in claim 14 wherein said bypass switch operates to release a tool for use in isolating the isolation system.

18. An equipment isolation system as claimed claim 17 wherein said tool is a cranking lever to engage with the racking mechanism of an electrical isolator for use in isolating or de-isolating the isolation system.

19. An equipment isolation system as claimed in claim 1 being a remote isolation system wherein said control system automatically isolates equipment in response to a permissible operator request logged at a remote isolation station.

20. An equipment isolation system as claimed in claim 19 wherein said remote isolation station is provided with a switch in said isolation system switch means.

21. An equipment isolation system as claimed in claim 20 wherein said switch is an equipment isolation lockout switch operable by said first key.

22. An equipment isolation system as claimed in claim 21 comprising a plurality of remote isolation stations each including an equipment isolation lockout switch operable by a dedicated first key, all of which are required by said key exchange unit before each said further key for performing said additional task is released.

23. An equipment isolation system as claimed in claim 1 being substituted, when in inoperative state, by an alternative equipment isolation system or process.

24. An equipment isolation system as claimed in claim 1 including monitors for securing the components of the equipment isolation system when in inoperative state.
